(19) United States
(12) Patent Application Publication
(10) Pub. No.: US 2011/0235630 A1
(43) Pub. Date: Sep. 29, 2011

(54) Techniques for prioritizing traffic

(76) Inventors: Jie Hui, Portland, OR (US); Ali T. Koc, Hillsboro, OR (US); Elad Levy, Nes Ziona (IL); Jing Zhu, Portland, OR (US)

(21) Appl. No.: 12/661,746

(22) Filed: Mar. 23, 2010

(51) Int. Cl. H04L 12/56; H04L 12/66

(52) U.S. Cl. 370/352; 370/412

(57) ABSTRACT

Techniques, at a subscriber station, for assigning packets to queues to prioritize real-time content over non-real time content. Packets with the same connection identifier are assigned to different priority queues. Block sequence numbers are assigned to packets after storage of packets to queues based on priority.

### FIELD

The subject matter disclosed herein relates generally to techniques for prioritizing content to be transmitted from a subscriber station in a wireless network.

### RELATED ART

Prioritization of traffic is an important feature in networking. Time sensitive packets are allowed to traverse the network more rapidly. In networks, routers prioritize packets based on priority of packet content. For example, IEEE 802.16-2009 at section 6.3.5 describes five different quality of service (QoS) scheduling priorities for different application requirements at the subscriber station for uplink content transmission and at the base station for downlink content transmission. However, current deployments of IEEE 802.16-2009 in the market provide a single scheduling service, namely, the lowest scheduling type, i.e., best effort (BE), to deliver all kinds of content such as video chatting and photo uploads. BE is described in section 6.3.5.2.4 of IEEE 802.16-2009. Using BE service, all applications including those that deliver real time and non-real time content are served on the same BE service without any different treatment. Photo uploads can involve non-real time delivery of content and users will accept delays in photo uploads. However, video chatting typically involves real-time video delivery and accordingly, use of BE service can cause unacceptable delays in video delivery.

### BRIEF DESCRIPTION OF THE DRAWINGS

Embodiments of the present invention are illustrated by way of example, and not by way of limitation, in the drawings and in which like reference numerals refer to similar elements.

FIG. 1 depicts two systems that can be used to transmit content from a subscriber station.

FIG. 2A depicts a known system that provides an ARQ BSN stamp prior to queuing.

FIG. 2B depicts an example of system where the ARQ BSN occurs after enqueueing of content into priority queues by local classifier.

FIG. 3 depicts a process in accordance with an embodiment.

FIG. 4 depicts an example system that can use embodiments of the present invention.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Embodiments of the invention may be used in a variety of applications. Some embodiments of the invention may be used in conjunction with various devices and systems, for example, a transmitter, a receiver, a transceiver, a transmitter-receiver, a wireless communication station, a wireless communication device, a wireless Access Point (AP), a modem, a wireless modem, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a network, a wireless network, a Local Area Network (LAN), a Wireless LAN (WLAN), a Metropolitan Area Network (MAN), a Wireless MAN (WMAN), a Wide Area Network (WAN), a Wireless WAN (WWAN), devices and/or networks operating in accordance with existing IEEE 802.11, 802.11a, 802.11b, 802.11e, 802.11g, 802.11h, 802.11i, 802.11n, 802.16, 802.16d, 802.16e, 802.16m, or 3GPP standards and/or future versions and/or derivatives and/or Long Term Evolution (LTE) of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (MISO) transceiver or device, a Multi Receiver Chain (MRC) transceiver or device, a transceiver or device having “smart antenna” technology or multiple antenna technology, or the like.

Some embodiments of the invention may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency Division Multiple Access (OFDMA), Time-Division Multiplexing (TDM), Time-Division Multiple Access (TDMA), Extended TDMA (E-TDMA), General Packet Radio Service (GPRS), Extended GPRS, Code-Division Multiple Access (CDMA), Wideband CDMA (WCDMA), CDMA 2000, Multi-Carrier Modulation (MDM), Discrete Multi-Tone (DMT), Bluetooth®, ZigBee™, or the like. Embodiments of the invention may be used in various other apparatuses, devices, systems and/or networks.

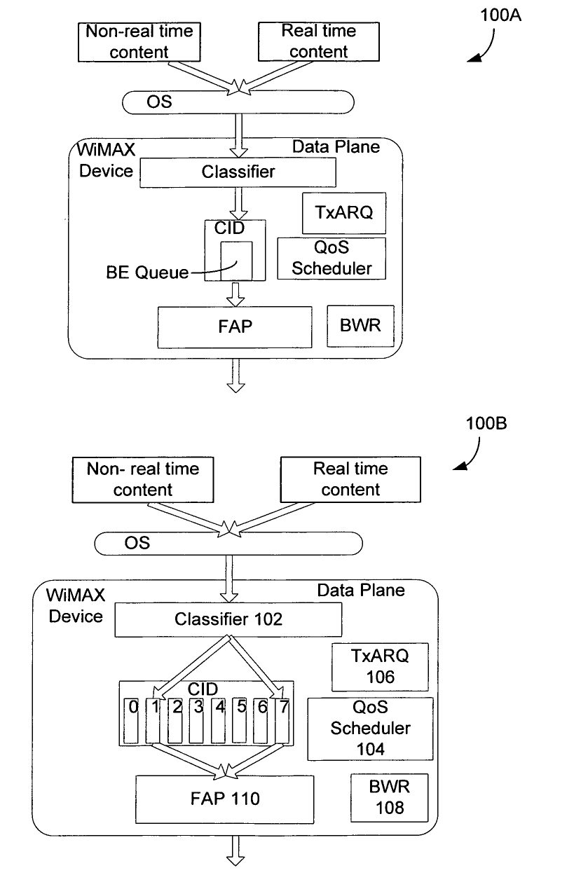

FIG. 1 depicts two systems that can be used to transmit content from a subscriber station. System 100A is a well-known system that uses a best efforts (BE) queue to prioritize content from different sources for transmission. If the Base Station (BS) supports a BE flow, packets from all applications are mapped to the same queue of one connection ID (CID) without prioritization. For example, non-real time and real time content are both mapped to the same CID queue. By contrast, system 100B includes classifier 102 that classifies packets involved in real-time communications such as voice or video communication at a higher priority than packets involved in non-real time communications such as photo uploads or audio uploads. System 100B can be used in any wireless communication network and is not limited to networks compliant with IEEE 802.16-2009.

An application layer (not depicted) of system 100B between the applications and classifier 102 forms the packet with appropriate headers and with content from the applications. Classifier 102 of system 100B maps application packets to different QoS queues within the same CID based on the type of content to be transmitted. In some cases, local classifier 102 assigns packets to queues that belong to the same CID. Although, packets from different CIDs can be mapped to queues. Classifier 102 also assigns a connection index (CIN) for each packet, where each CIN represents a priority level. For example, local classifier 102 can map packets to queues based on the CIN. In some embodiments, there are eight (8) different CIN. For example, a highest CIN value can correspond to a highest priority packet.

In some cases, classifier 102 can map packets to queues based on a Type of Service (ToS) field, described at least in RFC 3168, associated with each packet. The ToS field is in the IP header and can be generated by the OS or an application. In some cases, the ToS field ranges from priority 0 to 7.

In some cases, classifier 102 maps packets to queues based on the name of the application that requests packet transmission. The name of the transmitting application can be provided by the application to the network interface explicitly through a software interface, such as an API. Some applications are associated with transmission of real-time content whereas other applications are associated with transmission of non-real time content.

In some implementations, at least two queues can be used. For example, system 100B can include one or more queues for real-time communications and one or more queues for non-real time communications. For example, packets from any video or audio chat programs that use UDP as a transport protocol can be considered real-time and be given priority over non-real time applications that use TCP as a transport protocol. UDP is described in IETF RFC 768 (1980) and the TCP/IP protocol is described at least in the publication entitled “Transmission Control Protocol: DARPA Internet Program Protocol Specification,” prepared for the Defense Advanced Projects Research Agency (RFC 793) (September 1981).

QoS scheduler 104 schedules transmission of packets from queues based on the priority of the queue. For example, strict priority queuing can be used where contents of higher priority queues can be transmitted before contents of lower priority queues. Other scheduling mechanisms can be used such as weighted round robin, deficit weighted round robin, hierarchical fair service curve, weighted fair queuing, and class based weighted fair queuing.

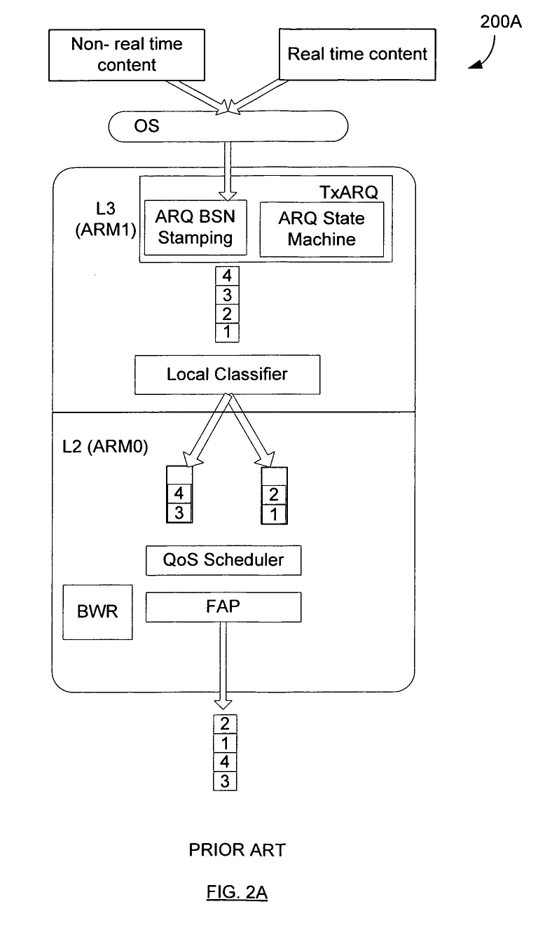

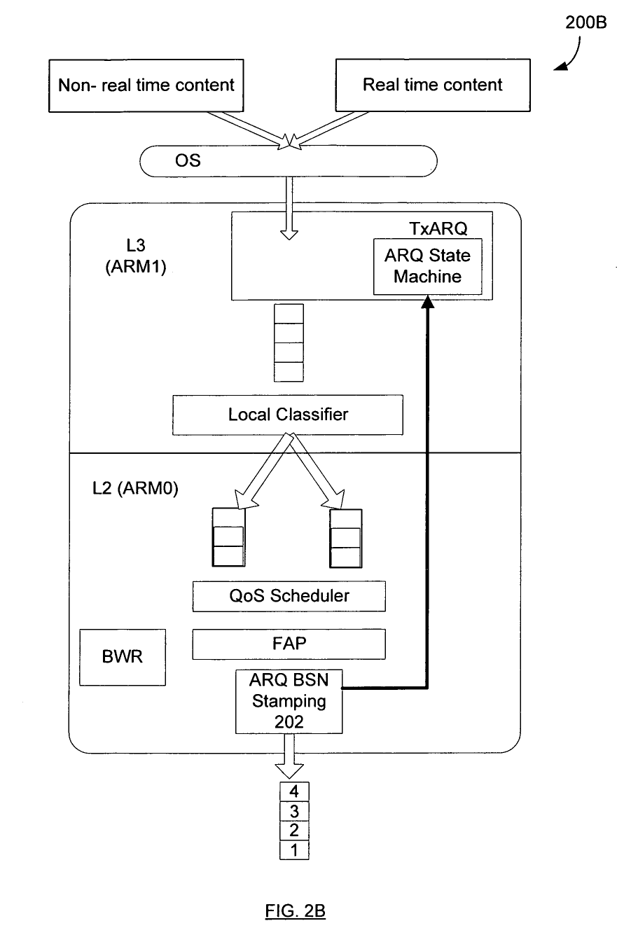

FIG. 2A depicts a known system 200A that provides an automatic repeat request (ARQ) BSN stamp at L3 prior to queuing in L2. For system 200A, TxARQ block provides Block Sequence Numbers (BSN), i.e., an order of sending Service Data Units (SDUs) of the same CID. Assigning a BSN to an SDU followed by reordering the SDUs may cause the order of transmission to not match the BSN of the SDUs. For example, the order of transmission of SDUs based on BSN is BSN 3, 4, 1, then 2, instead of an intended order of 1, 2, 3, then 4.

To enable local prioritization and reordering that comes from local prioritization, various embodiments provide ARQ BSN stamping 202 after SDUs are scheduled into a protocol data unit (PDU). FIG. 2B depicts an example of system 200B where the ARQ BSN 202 occurs after enqueueing of content into priority queues by local classifier. Assignment of BSN to packets from multiple queues is provided after sorting of packets into priority queues. In some cases, higher priority queues are given a lower BSN. Accordingly, after queuing, the order of transmission of packets is not disrupted because assignment of BSN permits transmission of packets in accordance with the priority of the queues.

Referring again to FIG. 1, bandwidth request aggregator (BWR) 108 aggregates bandwidth requests from multiple queues within the same CID to request bandwidth from a BS.

Fragmentation assembly and packing block (FAP) 110 is to aggregate MAC service data units (MSDUs) from queues of the same CID to a single MAC protocol data unit (MPDU). A single header can be used to transmit packets from multiple queues. In some cases, a single MSDU can generate multiple MPDUs. Thereafter, subscriber station system 100B can transmit packets to a base station.

Simulations show that video conferencing will suffer packet loss rate of 44% and delay of 417 ms when there is a concurrent FTP uploading of four 3 MB photo files on the same WiMAX (IEEE 802.16e) BE connection. After prioritization by enqueueing two applications into two different queues and scheduling real time packets to have priority over non-real time packets, the video conferencing quality improves significantly with packet loss rate reduced from 44% to 0.53% and delay reduced from 417 ms to 75.7 ms, while the FTP upload response time is increased from 143 s to 187.5 s as the trade off.

Results:

| | No prioritization | Prioritization |
|---|---|---|
| Video packet lose rate | 44% | 0.53% |
| Video E2E delay | 417 ms | 75.9 ms |
| Video delay variation | 18.5 ms | 0.014 ms |
| FTP upload time | 143 s | 187.5 s |

Simulation configuration: (1) WiMAX uplink speed: 2 Mbps, (2) real time application performing low resolution video conferencing 1.3824 Mbps, and (3) non-real time application uploading of four photos of 3 Mbytes each.

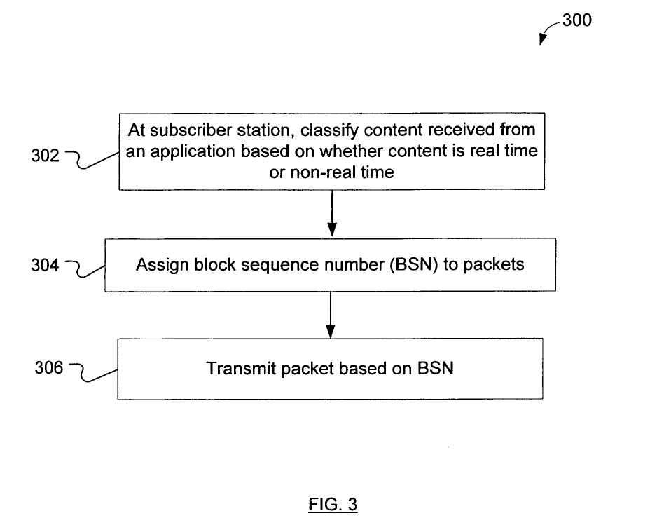

FIG. 3 depicts a process in accordance with an embodiment. Block 302 includes, at a subscriber station, classifying packets requested to be transmitted by applications based on whether the packet includes real time or non-real time content. For example, multiple queues with increasing priority levels can be available and content that is real-time can be assigned to higher priority queues. The queues can be used for prioritization of packets of the same connection identifier. In some cases, a Type of Service (ToS) field, described at least in RFC 3168, associated with each packet can be used to assign a queue to the packet. However, packets can be assigned to queues based on other factors such as the application requesting transmission, or the protocol used to transmit the packet.

Block 304 includes assigning a block sequence number (BSN) to packets from queues after the packets have been queued in block 302.

Block 306 includes transmitting the packets based on assigned BSN to a base station.

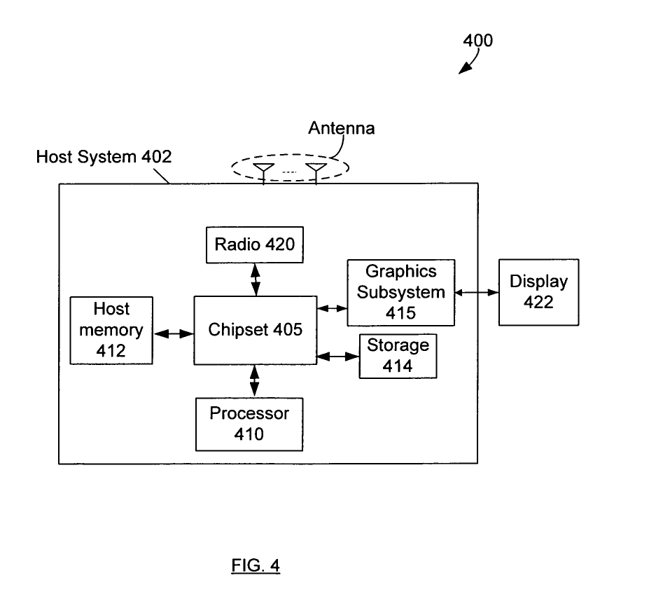

FIG. 4 depicts an example system that can use embodiments of the present invention. Computer system 400 may include host system 402 and display 422. Computer system 400 can be implemented in a handheld personal computer, mobile telephone, set top box, or any computing device. Host system 402 may include chipset 405, processor 410, host memory 412, storage 414, graphics subsystem 415, and radio 420. Chipset 405 may provide intercommunication among processor 410, host memory 412, storage 414, graphics subsystem 415, and radio 420. For example, chipset 405 may include a storage adapter (not depicted) capable of providing intercommunication with storage 414.

Processor 410 may be implemented as Complex Instruction Set Computer (CISC) or Reduced Instruction Set Computer (RISC) processors, x86 instruction set compatible processors, multi-core, or any other microprocessor or central processing unit. In various embodiments, processor 410 or radio 420 queues packets based on techniques described herein.

Host memory 412 may be implemented as a volatile memory device such as but not limited to a Random Access Memory (RAM), Dynamic Random Access Memory (DRAM), or Static RAM (SRAM). Storage 414 may be implemented as a non-volatile storage device such as but not limited to a magnetic disk drive, optical disk drive, tape drive, an internal storage device, an attached storage device, flash memory, battery backed-up SDRAM (synchronous DRAM), and/or a network accessible storage device.

Graphics subsystem 415 may perform processing of images such as still or video for display. An analog or digital interface may be used to communicatively couple graphics subsystem 415 and display 422. For example, the interface may be any of a High-Definition Multimedia Interface, DisplayPort, wireless HDMI, and/or wireless HD compliant techniques. Graphics subsystem 415 could be integrated into processor 410 or chipset 405. Graphics subsystem 415 could be a stand-alone card communicatively coupled to chipset 405.

Radio 420 may include one or more radios capable of transmitting and receiving signals in accordance with applicable wireless standards such as but not limited to any version of IEEE 802.11 and IEEE 802.16. For example, radio 420 may include at least a physical layer interface and media access controller.

Embodiments of the present invention may be implemented as any or a combination of: one or more microchips or integrated circuits interconnected using a motherboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

The drawings and the forgoing description gave examples of the present invention. Although depicted as a number of disparate functional items, those skilled in the art will appreciate that one or more of such elements may well be combined into single functional elements. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A method, performed at a subscriber station, the method comprising:
receiving a packet;
determining a priority of the packet;
requesting storage of the packet into a queue among multiple queues based in part on the priority of the packet;
assigning a block sequence number to the packet after storage of the packet into a queue; and
requesting transmission of the packet.

2. The method of claim 1, wherein the determining a priority of the packet comprises:
determining a priority based on a Type of Service (ToS) field associated with each packet.

3. The method of claim 1, wherein the determining a priority of the packet comprises:
determining a priority based on the name of an application that requests packet transmission.

4. The method of claim 1, wherein the determining a priority of the packet comprises:
determining a priority based on whether the application transmits time sensitive content or non-time sensitive content.

5. The method of claim 4, wherein the time sensitive content comprises one of video or voice communication.

6. The method of claim 4, wherein the non-time sensitive content comprises one of text, video, or photo uploading.

7. The method of claim 1, wherein requesting storage of the packet into a queue comprises:
mapping application packets within the same connection identifier among the multiple queues.

8. The method of claim 1, requesting storage of the packet into a queue comprises:
assigning a connection index to each packet based on the queue in which the packet is to be stored.

9. The method of claim 1, wherein each of the multiple queues are associated with a different priority of traffic.

10. A subscriber station comprising:
a local classifier to receive packets having the same connection identifier and to assign a queue among multiple queues based on a priority of the packet, wherein the multiple queues are associated with packets having the same connection identifier and
automatic repeat request logic to provide Block Sequence Numbers (BSN) to packets of the same connection identifier after the packets are classified into queues.

11. The subscriber station of claim 10, wherein the local classifier is to determine priority of the packet based on a Type of Service (ToS) field associated with each packet.

12. The subscriber station of claim 10, wherein the local classifier is to determine priority of the packet based on the name of the application that requests packet transmission.

13. The subscriber station of claim 10, wherein the local classifier is to determine priority of the packet based on whether the application transmits time sensitive content or non-time sensitive content.

14. The subscriber station of claim 10, wherein the local classifier is to assign a connection index to each packet based on the queue in which the packet is to be stored.

15. A subscriber station system comprising:
a display device and
a host system comprising:
a central processing unit to request content to be transmitted to a base station;
a local classifier to receive packets including the content having the same connection identifier and to assign a queue among multiple queues based on a priority of the packet, wherein the multiple queues are associated with packets having the same connection identifier; and
transmit automatic repeat request logic to provide Block Sequence Numbers (BSN) to packets of the same connection identifier after the packets are classified into queues.

16. The system of claim 15, wherein the local classifier is to determine priority of the packet based on a Type of Service (ToS) field associated with each packet.

17. The system of claim 15, wherein the local classifier is to determine priority of the packet based on the name of the application that requests packet transmission.

18. The system of claim 15, wherein the local classifier is to determine priority of the packet based on whether the application transmits time sensitive content or non-time sensitive content.

19. The system of claim 15, wherein the time sensitive content comprises one of video or voice communication and the non-time sensitive content comprises one of text, video, or photo uploading.

20. The system of claim 17, wherein the transmit automatic repeat request logic is to provide BSN to packets after packets are scheduled into a protocol data unit.
